(19) United States
(12) Patent Application Publication
(10) Pub. No.: US 2006/0176307 A1
(43) Pub. Date: Aug. 10, 2006

(54) Apparatus and method for turning of pages in a digitised virtual document

(76) Inventor: Wilhelm Lagercrantz, Stockholm (SE)

Correspondence Address: YOUNG & THOMPSON, 745 SOUTH 23RD STREET, 2ND FLOOR, ARLINGTON, VA, 22202, US

(21) Appl. No.: 10/509,100

(22) PCT Filed: Mar. 24, 2003
(86) PCT No.: PCT/SE03/00484

§ 371 Date: Jun. 20, 2005

(30) Foreign Application Priority Data
Mar. 27, 2002 (SE) 0200951-2

(51) Int. Cl. G06T 15/70; G06F 3/00

(52) U.S. Cl. 345/473; 715/776

(57) ABSTRACT

An apparatus and a method for displaying a digitised document to an audience. A memory (20) is provided for storing of at least one digitised document in a computer readable file format, wherein a processing unit (10) is adapted to retrieve documents and process it into a near-identical document replica. Moreover, a display (30) visualises document and animation of the document, such as the turning of a layer, being controlled by the audience. The function of the apparatus is characterised by the audience indicating when real-time animation of a layer (51, 52) is about to begin or revert to its initial state, and the indication is governed by crossing a dividing line with an indicating element substantially in lateral direction.

### TECHNICAL FIELD OF THE INVENTION

The present invention relates making valuable or rare documents accessible to the public in an attractive way. More in detail, the invention relates to an apparatus and a method for realistic turning of pages in a digitised document.

### BACKGROUND OF THE INVENTION

During the last 20 years, and in particular during the last decade, the development of information technology has created new and exciting possibilities. The information obtainable from the Internet has increased immensely. Users of computers and computer controlled equipment have become used to the ability of retrieving all kinds of information at high-rates and for the younger generation in particular, the Internet now represents the first choice when searching for information. The impact that the Internet will have on everyone's daily life cannot be overestimated, especially in a little longer perspective than a few years.

However, in order to have desired impact, information which is obtainable and accessible must also be introduced to its audience in an attractive manner. This is the case not the least in the fields of literature, history and cultural history. One way of displaying information in a special and attractive format is disclosed in the U.S. Pat. No. 5,463,725. The patent document discloses an interface providing a display where a document is made accessible to a reader in a similar manner to that of a printed book or magazine. The user is able to touch the display, thereby causing an animated turn of a page of the displayed material.

Even though both transmission and access technologies have improved significantly and many personal computer users of today access the Internet at rates up to over 2 Mbits/second bi-directionally, unreliable data transfer and network congestion is still a problem associated with-transmission of large data amounts. Not all users, especially not in countries less developed than countries in the industrialised world, have access to modem computer equipment of sufficient performance for carrying out demanding tasks, such as displaying and processing facsimile documents and photography in good quality.

Displaying printed media on a typical display monitor usually does not do justice of a literature masterpiece or a painting. The resolution is often limited to the extent allowed by a particular technology in use, whether the bottle neck is poor screen resolution or transmission capacity. The effect of depth in a painting or the number of pages left to the end of a story is also lacking when digitally visualising printed media two-dimensionally on a screen.

When data transmission is either completely lacking or at least unreliable, another low-tech transmission technology which is always possible is to send for instance a CD-ROM per mail to the recipient containing all required information. However, that requires the data to be in a format allowed by a CD-ROM or to be compressible in order to be allowable by the limited format of the memory.

### SUMMARY OF THE INVENTION

It is therefore an object of the present invention to introduce an apparatus and method for displaying a digitised document to an audience, the apparatus comprising,
persistent memory, for storage of at least one digitised document in a computer readable file format,
processing means, adapted to retrieve the digitised document from the persistent memory, and process the computer readable file format into a near-identical document replica,
display for visualising the digitised document having interface which represents a view of the digitised document, where animation of the document, such as the turning of a layer, being controlled by the audience,
an active field of the display is laterally enclosed by at least one dividing line,
   characterised in that
the animation of a layer to be turned is adapted to either begin or revert to its initial state in real-time upon-indications by the audience, the indications governed by substantially in lateral direction crossing of the dividing line with an indicating element.

An advantage of the present invention is that irregularities in edges of a digitised book or other document are maintained during the visualisation. This greatly enhances the realistic impression of the document, as experienced by-the audience. The realistic impression enables a much simpler animation than animation technologies of prior art, still without loosing the realistic impression of the document. This rough presentation of the edges in combination with the real-time controlled animation pages that are turned, an animation controllable in both directions and imitating the force of gravity, makes it possible to avoid deliberate deterioration of the image resolution while animating the turning of a page. This deterioration of the digitised facsimile image is otherwise unavoidable, or at least calls for modern and high performing computer equipment, equipment which is costly. One of the prerequisites when displaying images to an audience is a high resolution, which inevitably leads to large documents with respect to digital memory capacity.

Further advantages and benefits of the present invention will be evident from the dependent claims.

### BRIEF DESCRIPTION OF THE DRAWINGS

The above and further features, advantages and benefits of the present invention will be apparent upon consideration of the following detailed description, taken in conjunction with the accompanying drawings, in which like reference characters and figures refer to like parts throughout, and in which:

FIG. 1 illustrates a schematic view of the apparatus for displaying digitised documents, according to the present invention.

FIG. 2 discloses the outline of the document visualisation and features used for turning pages on audience command, according to the present invention.

FIG. 3 is a flow chart outlining of sequential principles when turning pages in a digitised document on audience command according to the present invention.

### DETAILED DESCRIPTION OF EMBODIMENTS

The following description is of the best mode presently contemplated for practising the invention. The description is not to be taken in a limiting sense, but is made merely for the purpose of describing the general principles of the invention. The scope of the invention should be ascertained with reference to the issued claims.

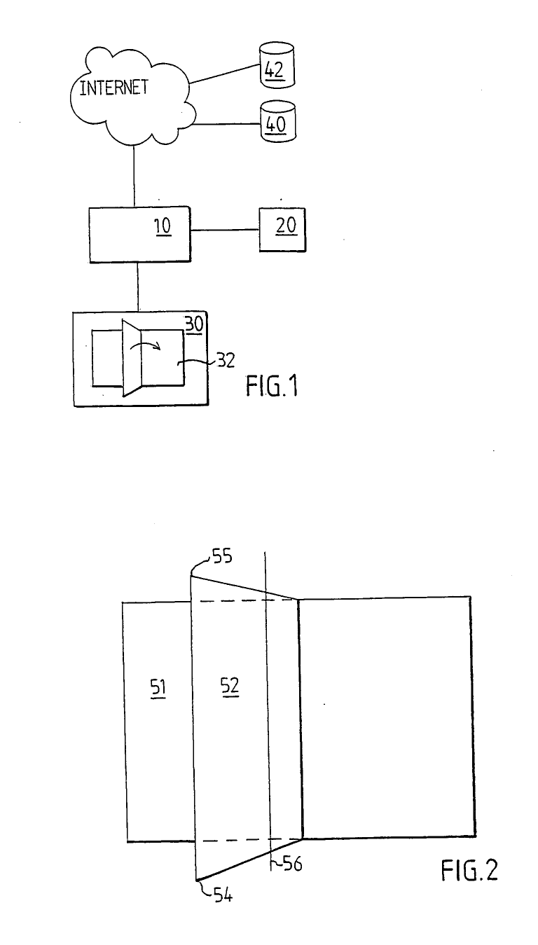

Referring to FIG. 1, a schematic view of the apparatus for displaying digitised documents is shown. Digitised documents such as photographs or scanned high resolution pictures are stored in a persistent memory 20. Conceivable is of course a memory such as a hard disk or CD-ROM, but any other kind of suitable digital storage means can be utilised. A processing means 10 is connected to the memory for retrieval of document data and subsequent processing of the data into a picture format to be displayed. The display 30 is a screen, preferably a so-called touch screen which can be controlled on user command by pressing a finger onto different predefined areas on the screen, thereby influencing the operation of the software product displayed on-the screen.

As previously mentioned, documents to be visualised may be retrieved from a persistent memory. However, various databases 40,42 connected to the Internet may also be accessed from the processing-means, via its Internet connection. This simplifies the distribution of documents to be visualised since one digitised document is stored centrally, but visualised at different clients. Charging schemes may also be applied, the schemes coupled-to entities wanting to visualise a certain document to an interested audience. This may be-the case for an art exhibition, or a travelling literature seminar as two feasible examples among many more.

With reference to FIG. 2, the general outline of the document visualisation interface 32 is disclosed with its related features used for enabling a turning of pages on audience command. The interface includes at least two layers, among them a first background layer 51 and a second foreground layer 52. The foreground layer covers the background layer as to simulate a real page turning, in a book or a magazine for instance. The page to be turned comprises a corner co-ordinate in each outer corned of the page, more specifically one upper corner co-ordinate 55 and a lower corner co-ordinate 54. When turning a page, those corner co-ordinates are separated from one another a distance which exceeds the distance between the co-ordinates when a page turning is not yet activated. This separation bear a close resemblance to the page turning of a real book or magazine, since it is adapted to create a sense of depth to the two-dimensional screen layout of the digitised document which is visualised.

For deciding whether to turn a page on user command, the user has to cross a pre-determined dividing line 56 with the indicating finger movement. In an alternative embodiment of the present invention, a cursor control device is used for the same purpose, i.e. for indicating whether to turn a page, or to interrupt an initialised page turn and let the page fall back to its original position before the turning of the page was initialised.

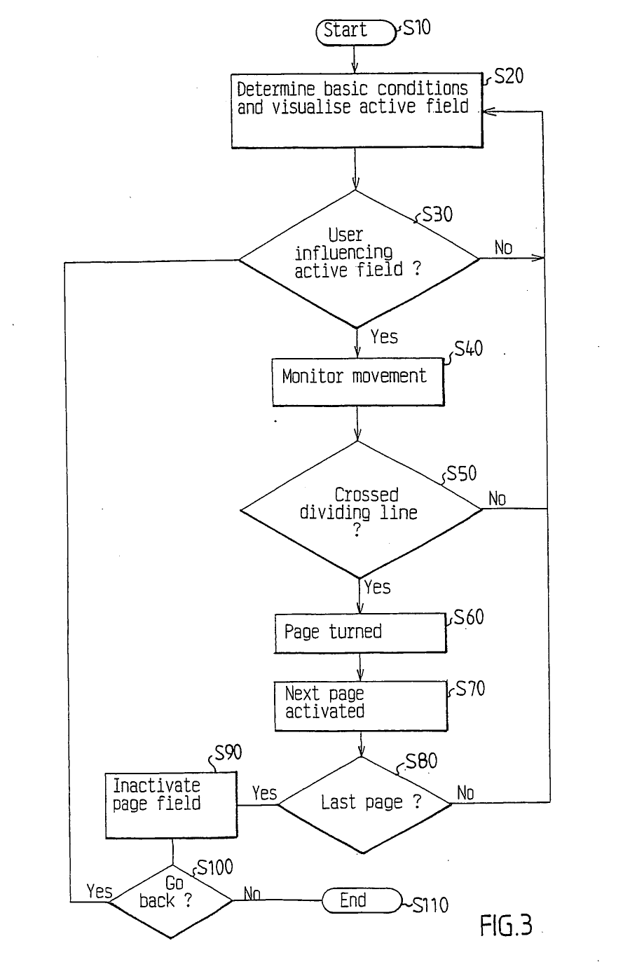

FIG. 3 is a flow chart outlining of sequential routine applied when turning pages in a digitised document on finger tip command by the audience in accordance with the present invention. The method of turning-pages starts (S10) with determining the number of pages in a stacked pile of documents, such for instance a scanned or photographed book or magazine to be visualised. For performance reasons, only four pages can be displayed at a time, whereby the application can be run without congestion problems or lack of memory capacity also on relatively simple computer equipment available at comparably moderate prices. Next, several basic conditions are determined (S20), on which the visualisation is based. For example, the dimensions of the pages to be shown are calculated and a limiting dividing line 56 is established. The dividing line is used for deciding whether a page is to be turned or not in direct response to finger tip commands of a user. The perspective is chosen by the user among a set of predefined perspectives, each of them suitable for different reasons and depending on the nature of the digitised document to be visualised. The perspective depends for example on the page width of particular book, i.e. large pages yield quite another appearance than small pages. Also the roughness of pages greatly effects the visualisation, which can be tuned and thereby managed by the user's choice of perspective.

An active field is displayed, and the user influences (S30) this active field either by moving his or her finger tips when a touch screen is used, or by moving a cursor by a cursor control device. The movement of finger tips or a corresponding cursor symbol is monitored (S40) by the apparatus by calculating its position in relation to the position of the dividing line 56. As long as the user of the turning page application does not actively cross (S50) the dividing line 56, the active filed is continuously visualised (S20). When the dividing line is crossed (S50), i.e. user command is given, the application interprets this as an attempt to virtually turn a page and in response a page turning procedure is initialised (S60). The procedure of turning a page can be interrupted by moving the finger back into the active field and as in response to this, no corresponding action is started. As a result of the turned page, the following page is highlighted (S70), i.e. switches from an inactivated to an activated operational mode by a virtual background illumination. This procedure continues until-the last page in a stacked pile of digitised documents to be visualised is reached (S80). Reaching the last page results in an inactivation (S90) of the page visualisation and the background being displayed. This may be when a visualised book or other document is closed and therefore no next page is to be displayed, or the next page is actively vanished. Subsequently, the procedure continues in that the user has a choice among new documents to be visualised from an index of documents, the index continuously accessible for the user via the user interface, or to terminate the visualisation. According to an alternative embodiment, the user can be queried (S100) whether to go back or chose another document for visualisation. In case this is desired by the user, the sequence continues by monitoring (S30) the user activity again, otherwise the sequence ends (S110). According to the invention, there is an additional feature to display for instance every tenth page in a stacked pile of documents instead of displaying every single page. This is particularly useful when a whole document intentionally is to be covered in short time or in less detailed manner than if every single page is to be visualised. However, the interval between pages to be displayed does not have to be ten as proposed, but may be any other predetermined number or a number chosen on user command.

In accordance with the present invention, software is developed in parallel with the apparatus for visualising digitised documents. The software resides in a memory located of the hardware associated with said apparatus. The software is designed for instructing the hardware of visualisation means to carry out the sequential method steps described with reference to FIG. 3.

1. Apparatus for displaying a digitised document to an audience, the digitised document for visualisation being printed media, such as high resolution photographs of pages in a book, the apparatus comprising,
persistent memory (20), for storage of at least one digitised document in a computer readable file format,
processing means (10), adapted to retrieve the digitised document from the persistent memory, and process the computer readable file format into a near-identical document replica,
display (30) for visualising the digitised document having interface (32) which represents a view of the digitised document, where animation of the document, such as the turning of a layer, being controlled by the audience,
an active field of the display is laterally enclosed by at least one dividing line (56),
characterized in that
the animation of a layer (51, 52) to be turned is adapted to either begin or revert to its initial state in real-time upon indications by the audience, the indications governed by substantially in lateral direction crossing of the dividing line with an indicating element.

2. Apparatus for displaying a digitised document according to claim 1, characterized in that
layers in a digitised document being visualised to the audience on the display are provided with edges being irregularly cut.

3. Apparatus for displaying a digitised document according to claim 1, characterised in that
layers in a digitised document are superimposed while still displaying edges so as to convey information to the audience on how far the visualised document is from the beginning and end of a stack of layers.

4. Apparatus for displaying a digitised document according to claim 1, characterised in that
digitised documents are retrieved from at least one database (40, 41) accessible from the processing means via the Internet or any other global interconnecting network.

5. Apparatus for displaying a digitised document according claim 1, characterised in that
the display is a touch screen, sensitive to signals governed by the audience by touching and dragging a finger tip on the visualised layer so as to indicate when a layer is to be turned.

6. Apparatus for displaying a digitised document according to claim 1, characterised in that
the indicating element is either a finger moved on a touch screen or a cursor moved by a cursor control device.

7. Apparatus for displaying a digitised document according to claim 1, characterised in that
the audience is able to adapt the default appearance of the visualisation, in order to choose among a predefined set of suitable perspectives for the visualisation of the digitised document.

8. Apparatus for displaying a digitised document according to claim 1, characterised in that
the persistent memory being any kind of storage location connected to the processor, such as CD-ROM, any kind of memory disk, flash memory, etc.

9. Apparatus for displaying a digitised document according to claim 1, characterised in that
the interface is provided with links to translations of the digitised document, the translations being into languages desired by the user and being accessible on user command.

10. Apparatus for displaying a digitised document according to claim 1, characterised in that
layers in a digitised document are displayed with delimiting intervals, the delimiting intervals being set in advance or on user command.

11. Method for displaying a digitised printed media document to an audience by utilising a memory (20) for storing of at least one digitised document in a computer readable file format, wherein a processing means (10) is adapted to retrieve documents and process it into a near-identical document replica, a display (30) visualises document and animation of the document, such as the turning of a layer, being controlled by the audience, the method characterised by the steps of:
indicating by the audience when real-time animation of a layer (51, 52) is about to begin or revert to its initial state, the indication governed by crossing a dividing line with an indicating element substantially in lateral direction.

12. Method for displaying a digitised document according to claim 11, further characterised by the step of:
visualising on the display layers which have irregularly cut edges.

13. Method for displaying a digitised document according to claim 12, further characterised by the step of:
visualising superimposed layers forming a stack of layers, while still displaying their edges, thereby conveying information to the audience on how far the visualisation is from the beginning and end of the stack.

14. Computer program product for displaying a digitised printed media document to an audience, fully integrated in an apparatus according to claim 1.
